(19) United States
(12) Patent Application Publication
(10) Pub. No.: US 2009/0308187 A1
(43) Pub. Date: Dec. 17, 2009

(54) LINEAR ACTUATOR FOR RECLINING FURNITURE

(76) Inventor: Kurt SCHMID, Buende (DE)

Correspondence Address: K.F. ROSS P.C., 5683 RIVERDALE AVENUE, SUITE 203 BOX 900, BRONX, NY, 10471-0900, US

(21) Appl. No.: 12/483,272

(22) Filed: Jun. 12, 2009

(30) Foreign Application Priority Data
Jun. 13, 2008 (DE) 102008028335.5-12

(51) Int. Cl. F16H 25/20

(52) U.S. Cl. 74/89.4

(57) ABSTRACT

A linear actuator for reclining furniture has a rotary motor that can axially displace a nonrotatable inner tube coaxial engaged in an axially fixed and nonrotatable outer tube, with the inner tube projecting axially forward from an end of the outer tube. An inner sleeve coaxially fits around the end of the outer tube and is axially traversed by the inner tube, and an outer sleeve coaxially fits around the inner sleeve, projects axially forward and rearward past the inner sleeve, and ix axially traversed by the inner tube. The outer sleeve has axially forward of the inner sleeve a radially inwardly projecting collar engaged around the inner tube and bearing axially rearwardly on the inner sleeve.

### FIELD OF THE INVENTION

The present invention relates to an actuator for a piece of reclining furniture. More particularly this invention concerns an actuator whose output element moves in a straight line.

### BACKGROUND OF THE INVENTION

A typical linear actuator for a chair or sofa has a housing in which an electric drive motor is provided that itself has a spindle that can rotate about its axis but not move axially. This spindle is guided in an outer tube attached to the housing and holding a nut that cannot rotate and from a front end of which extends a torque tube. A free front end of the torque tube can be connected to components to be moved of the furniture. An inner sleeve or first protective cap is fitted onto the front end of the outer tube and is axially traversed by the inner torque tube. Such an actuator is known, for example, from DE 295 00 084.

With the known arrangement an inner sleeve is usually placed on the front face of the jacket tube in which the torque tube is guided. This inner sleeve serves as guide and as a sliding aid as well as a dust guard. If known actuators of this type are exposed to moisture or wetness, moisture can get into the gap between the inner sleeve and the torque tube, which in most cases is undesirable.

Although a drive for an adjustment device is known from DE 297 10 298 that is made largely moisture-tight, a protective cap with interior seals is already placed on the front face of the jacket tube with the original equipment. This protective cap is axially traversed by the spindle of the drive. An embodiment of this type is useable for the factory production of an actuator of this type in a sealed embodiment. However, if existing actuators without this type of moisture protection are to be retrofitted with a corresponding moisture protection, there is no simple solution for this.

### OBJECTS OF THE INVENTION

It is therefore an object of the present invention to provide an improved linear actuator for reclining furniture.

Another object is the provision of such an improved linear actuator for reclining furniture that overcomes the above-given disadvantages, in particular that is of simple construction and can be made such that moisture protection can be retrofitted easily.

### SUMMARY OF THE INVENTION

A linear actuator for reclining furniture thus has as described above a rotary motor that can axially displace a nonrotatable inner tube coaxial engaged in an axially fixed and nonrotatable outer tube, with the inner tube projecting axially forward from an end of the outer tube. According to the invention an inner sleeve coaxially fits around the end of the outer tube and is axially traversed by the inner tube, and an outer sleeve coaxially fits around the inner sleeve, projects axially forward and rearward past the inner sleeve, and ix axially traversed by the inner tube. The outer sleeve has axially forward of the inner sleeve a radially inwardly projecting collar engaged around the inner tube and bearing axially rearwardly on the inner sleeve. A rear seal ring bears radially inward on the outer tube, axially forward on a rear end of the inner sleeve, and radially outward on an inner surface of the outer sleeve. A front seal ring bears radially inward on the inner tube and radially outward on the collar of the outer sleeve.

This embodiment makes it easy to retrofit a conventional linear actuator with a moisture protection in that the outer sleeve or second protective cap is placed onto the inner sleeve. Water tightness is achieved through the corresponding arrangement of seal rings. An embodiment of this type is easy to retrofit, so that conventional actuators can be retrofitted with a moisture safeguard of this type (in the factory or also later during use).

For assembly, first of all the first seal ring is pushed over the inner sleeve until it is positioned in rearward of the rear end of the inner sleeve. Subsequently, the outer sleeve is pushed onto the inner sleeve so that the seal ring or rings are pressed by the collar of the outer sleeve against the outer surface of the torque tube and create a seal with respect to this surface. With its end the outer sleeve overlaps the O-ring at the rear end of the inner sleeve and compresses it, so that a secure positioning and sealing is achieved.

The rear end of the outer sleeve has a bevel so that accurate positioning and easy assembly is assured. When pushing the outer sleeve onto the inner sleeve, the front seal fits in the area of the seal immediately rearward of the rear end of the inner sleeve into this bevel and is radially compressed.

In the area of the collar of the outer sleeve preferably two O-rings are arranged one behind the other so that excellent sealing against the entry of water is assured.

In order to ensure that, despite the arrangement of the seals, the torque tube can be displaced easily and in particular also moved quietly through the seals in the area of the collar of the outer sleeve, the front end of the inner sleeve is supported on the collar of the outer sleeve and an oil-impregnated felt ring is engaged between an annular rear face of the outer-sleeve collar and the front end of the inner sleeve so that it bears radially inward on the cylindrical outer surface of the inner tube. This oil-soaked felt ring ensures that the surface of the torque tube with the axial movement thereof in the outer tube on the felt ring applies to it a sufficient oil film so that sliding is facilitated in the area of the seals of the collar of the outer sleeve. Furthermore, quiet movement of the torque tube is hereby achieved.

In order to be able to fix the outer sleeve in a simple manner after the proper assembly it is furthermore provided that the outer sleeve is fixed to the inner sleeve by screws parallel to the tube axis, extending through the collar of the outer sleeve and into the front end of the inner sleeve. An axial position locking of the outer sleeve in the assembly desired position is achieved through this arrangement.

### BRIEF DESCRIPTION OF THE DRAWING

The above and other objects, features, and advantages will become more readily apparent from the following description, reference being made to the accompanying drawing in which:

FIG. 1 is an exploded view of the elements of the actuator before assembly;

FIG. 2 is the same view when fully assembled;

FIG. 3 is a section taken along line III-III of FIG. 2.

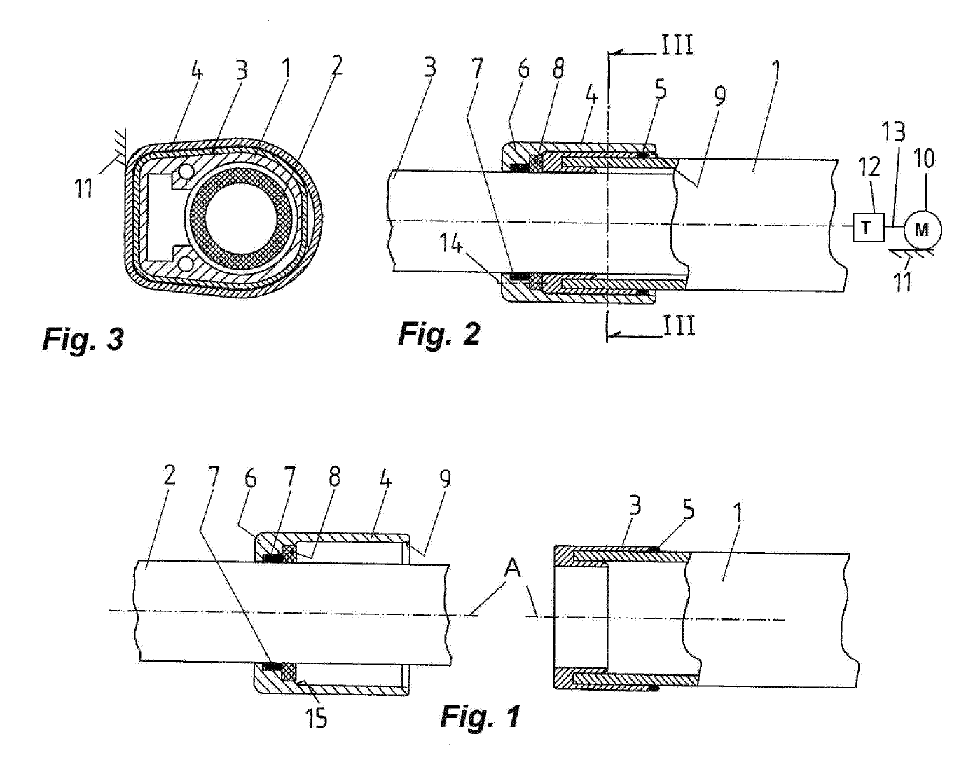

### SPECIFIC DESCRIPTION

Only the essential elements of an actuator for seating and/or lounge furniture are shown in the drawing.

As a rule, a linear actuator of this type comprises a housing 11 carrying an electric drive motor 10 having a threaded drive shaft or spindle 13 that can rotate about an axis A but not move axially. This drive shaft extends coaxially in a fixed outer tube 1 attached to the housing and is connected by a transmission 12 to the shaft 1. This transmission 12 comprises an unillustrated nut 12 that cannot rotate but that is splined so as to be axially movable in the outer tube 1. Thus as the drive spindle 13 rotates this nut of the transmission 12 moves axially. An output shaft or inner tube 2 coaxially received in the outer tube 1 is fixed to this nut so that rotation of the motor output spindle 13 axially displaces the shaft 2 in a direction determined by the rotation direction of the motor drive shaft 13. Such a system creates a significant mechanical advantage yet is very compact and completely closed. The end of the torque tube 2 is usually connected to a component of the furniture to be moved or the like.

A first protective inner sleeve or cap 3 is fitted on the front end of the fixed outer tube 1. This cap 3 is made of a suitable material, for example, plastic and axially traversed by the torque tube 2. In order to create a moisture-tight arrangement with an existing actuator of this type, a plastic outer sleeve 4 is provided that is fitted over the inner sleeve 3. In the assembled condition the rear end of the outer sleeve 4 projects somewhat beyond the rear end of the inner sleeve 3, which itself is juxtaposed with the housing 11 as can be seen, for example, in FIG. 2. A seal ring 5 bears axially against the rear end of the inner protective cap 3 and bears radially inward against the cylindrical outer surface of the outer tube 1 and radially outward on the cylindrical inner surface of the rear end of the outer protective cap 4. Thus a moisture-tight arrangement is achieved in this rear end area.

In addition the outer sleeve 4 has an inwardly projecting collar 6 on its front end remote from the housing 11, and the inner sleeve or cap 3 bears axially forwardly on a frustoconical shoulder 15 formed by this collar 6. The collar 6 carries on its inner surface facing radially inward toward the tube 2 two seal rings 7 in respective circumferential grooves so that the collar 6 and the seal rings 7 bear on the outer surface of the torque tube 2. A moisture-tight arrangement is thus also achieved in this front end area. A conventional drive can be retrofitted with a corresponding outer sleeve 4 so that an arrangement not previously moisture tight per se can be made moisture-tight.

In order to improve the sliding ability of the torque tube 2 and to reduce noise generation in the area of the seals 7, the front end of the inner sleeve 3 carries an oil-impregnated felt ring 8 being interposed that bears radially outward on the collar 6 and radially inward on the cylindrical outer surface of the torque tube 2, namely in the immediate vicinity of the seals 7. This way movement of the torque tube 2 creates an oil film on its outer surface, so that friction with the torque tube is reduced and the generation of noise in particular in the area of the seals 7 is counteracted.

Preferably the outer sleeve 4 is fixed on the inner sleeve 3 by means of screws shown schematically at 14. These screws 14 extend parallel to the axis A, engaging through the collar 6 of the outer sleeve 4 and into the front end of the inner sleeve 3.

In order to assembly, the rear end of the outer sleeve 4 facing away from the collar 6 is provided on the opening side with a feed bevel 9, here a frustoconical surface centered on the axis A and flaring axially rearward. This facilitates fitting the outer sleeve 4 over the seal ring 5. FIG. 2 shows the finished assembled unit.

The design according to the invention makes possible a simple and cost-effective retrofitting of a moisture-tight embodiment with conventional actuators.

The invention is not limited to the illustrated embodiment, but can be varied in many ways within the scope of the disclosure. All of the new individual and combination features disclosed in the specification and/or the drawing are considered to be essential to the invention

I claim:

1. In a linear actuator for reclining furniture where a rotary motor can axially displace a nonrotatable inner tube coaxial engaged in a nonrotatable outer tube and projecting axially forward from an end thereof, the improvement comprising:
an inner sleeve coaxially fitted around the end of the outer tube and axially traversed by the inner tube;
an outer sleeve coaxially fitted around the inner sleeve, projecting axially forward and rearward past the inner sleeve, and axially traversed by the inner tube, the outer sleeve having axially forward of the inner sleeve a radially inwardly projecting collar engaged around the inner tube and bearing axially rearwardly on the inner sleeve;
a rear seal ring bearing radially inward on the outer tube, axially forward on a rear end of the inner sleeve, and radially outward on an inner surface of the outer sleeve; and
a front seal ring bearing radially inward on the inner tube and radially outward on the collar of the outer sleeve.

2. The improvement defined in claim 1, further comprising
an oil-soaked lubricant ring engaged snugly around the inner tube between the collar and a front end of the inner sleeve.

3. The improvement defined in claim 1, further comprising at least one screw engaged axially through the collar into the inner sleeve and securing the sleeves axially together.

4. The improvement defined in claim 1 wherein the rear sleeve has an inner end formed with a rearwardly flaring bevel.

5. The improvement defined in claim 1 wherein the inner sleeve is of J-section with an axially rearwardly open U-shaped front end that fits over the front end of the outer tube.

6. The improvement defined in claim 1 wherein the sleeves are made of plastic.

7. The improvement defined in claim 1 wherein the outer sleeve axially rearward of the outer seal an axially rearwardly facing shoulder against which the inner sleeve bears axially forwardly.
